(19) United States
(12) Patent Application Publication
(10) Pub. No.: US 2023/0376416 A1
(43) Pub. Date: Nov. 23, 2023

(54) Optimizing Provisioning Certification Caching Service Protocol for Performance Improvement and Scalability

(71) Applicant: Intel Corporation, Santa Clara, CA (US)

(72) Inventors: Liang FANG, Shanghai (CN); Ziye YANG, Shanghai (CN); Weiwei ZHU, Shanghai (CN)

(21) Appl. No.: 18/361,964

(22) Filed: Jul. 31, 2023

(30) Foreign Application Priority Data
Feb. 16, 2023 (WO) PCT/CN2023/076380

(51) Int. Cl. G06F 12/0802

(52) U.S. Cl. CPC G06F 12/0802; G06F 2212/60

(57) ABSTRACT

Various examples relate to an apparatus, a device, a method, a computer program, and a non-transitory computer-readable medium for a computer system, to a computer system and to a system. The apparatus comprises interface circuitry, machine-readable instructions, and a processor to execute the machine-readable instructions to obtain a request to perform remote attestation for a trusted execution environment from an application running in the trusted execution environment of the processor, communicate with at least one remote attestation caching server based on the request to perform remote attestation, wherein the communication with the remote attestation caching server comprises providing a plurality of requests to the remote attestation server and obtaining a plurality of responses from the remote attestation caching server, and provide a result of the remote attestation request to the application running in the trusted execution environment after having completed the communication with the remote attestation server.

### BACKGROUND

Caching is a technique used in computer systems to improve performance by temporarily storing frequently accessed data or resources. When a user requests a particular piece of data, the system first checks the cache to see if it already has a copy. If the data is found in the cache, it can be retrieved much faster than if it had to be fetched from the original source. This is because accessing data from cache is typically quicker due to its proximity to the processor.

There are various types of caches used in different computing scenarios. One common type is the web cache, which is implemented in web browsers to store web pages and assets like images and scripts. When a user revisits a website, the browser can retrieve the files from cache instead of downloading them again, resulting in faster page load times. Caching is also employed at different levels in computer systems, such as within CPUs and in databases. Another form of caching is used for remote attestation of trusted execution environments.

Caching has several advantages in addition to improving performance. It helps reduce network traffic and bandwidth usage, as data that is already cached does not need to be transmitted again. This can be particularly beneficial in scenarios where multiple users access the same data or resources. Caching can also minimize the load on servers and databases, as the cached data can be readily served without putting additional strain on these systems. Overall, caching plays a crucial role in improving system efficiency and enhancing user experience by accelerating data access and reducing resource consumption.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system, of a computer system comprising such an apparatus or device, and of a system;

FIG. 1b shows a flow chart of an example of a method for a computer system;

FIG. 2a shows a schematic diagram of caching of provisioning certifications with a single caching server;

FIG. 2b shows a schematic diagram of caching of provisioning certifications with multiple caching servers;

FIG. 3a shows a flow diagram of an example of a caching flow for obtaining a quote in remote attestation;

FIG. 3b shows a flow diagram of an example of an improved caching flow for obtaining a quote in remote attestation;

FIG. 4 shows a diagram highlighting performance improvements obtained by scaling a number of caching servers;

FIG. 5 shows a block diagram of an electronic apparatus;

FIG. 6 shows a block diagram of a computing device; and

FIG. 7 shows a block diagram of a computing system.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

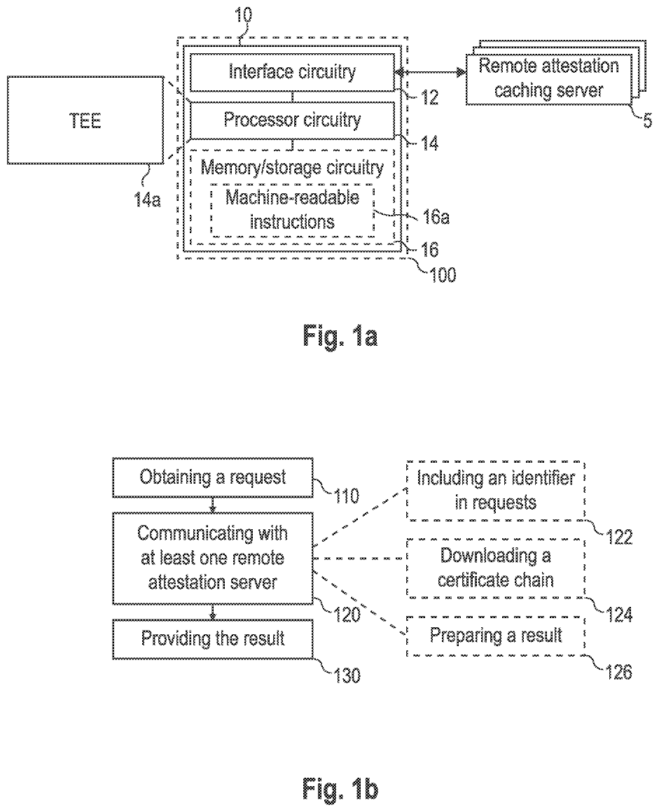

FIG. 1a shows a schematic diagram of an example of an apparatus 10 or device 10 for a computer system 100. The apparatus 10 comprises circuitry to provide the functionality of the apparatus 10. For example, the circuitry of the apparatus 10 may be configured to provide the functionality of the apparatus 10. For example, the apparatus 10 of FIG. 1b comprises interface circuitry 12, processor 14, and (optional) memory/storage circuitry 16. The processor 14 comprises a trusted execution environment 14a. For example, the processor 14 may be coupled with the interface circuitry 12 and with the memory/storage circuitry 16. For example, the processor 14 may provide the functionality of the apparatus, in conjunction with the interface circuitry 12 (for communicating with another computer system or entity, such as a remote attestation caching server 5), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1b comprises means for processing 14 (with a trusted execution environment 14a), which may correspond to or be implemented by the processor 14, means for communicating 12, which may correspond to or be implemented by the interface circuitry 12, (optional) means for storing information 16, which may correspond to or be implemented by the memory or storage circuitry 16. In general, the functionality of the processor 14 or means for processing 14 may be implemented by the processor 14 or means for processing 14 executing machine-readable instructions. Accordingly, any feature ascribed to the processor 14 or means for processing 14 may be defined by one or more instructions of a plurality of machine-readable instructions. The apparatus 10 or device 10 may comprise the machine-readable instructions 16a, e.g., within the memory or storage circuitry 16 or means for storing information 16, as shown in FIG. 1b. FIG. 1a further shows the computer system 100 comprising the apparatus 10 or device 10. FIG. 1a further shows a system comprising the apparatus 10 or device 10 (e.g., the computer system 100) and the remote attestation caching server 5.

The processor 14 or processing circuitry 14 is to obtain a request to perform remote attestation for a trusted execution environment 14a from an application running in the trusted execution environment of the processor. The processor 14 or processing circuitry 14 is to communicate with at least one remote attestation caching server 5 based on the request to perform remote attestation. The communication with the remote attestation caching server comprises providing a plurality of requests to the remote attestation server and obtaining a plurality of responses from the remote attestation caching server. The processor 14 or processing circuitry 14 is to provide a result of the remote attestation request to the application running in the trusted execution environment after having completed the communication with the remote attestation server.

FIG. 1b shows a flow chart of an example of a corresponding method for the computer system 100. The method comprises obtaining 110 the request to perform remote attestation for the trusted execution environment from the application running in the trusted execution environment of the processor of the computer system. The method comprises communicating 120 with the at least one remote attestation caching server 5 based on the request to perform remote attestation. The communication with the remote attestation caching server comprises providing a plurality of requests to the remote attestation server and obtaining a plurality of responses from the remote attestation caching server. The method comprises providing 130 the result of the remote attestation request to the application running in the trusted execution environment after having completed the communication with the remote attestation server. For example, the method may be performed by the computer system 100, e.g., by the apparatus 10 or device 10 of the computer system 100.

In the following, the features of the apparatus 10, device 10, computer system 100, method and of a corresponding computer program are discussed in more detail with reference to the apparatus 10. Features discussed with reference to the apparatus 10 may likewise be included in the corresponding device 10, computer system 100, method and computer program.

Remote attestation is a security mechanism in which a computing device, such as a server, provides evidence of its software and/or hardware configuration to a remote entity, such as a client device. It allows the remote entity to verify and attest to the integrity and trustworthiness of the computing device. For example, the remote attestation may convince the remote entity to share confidential information with the computing device. In the present case, remote attestation is used to demonstrate that an application is running in a trusted execution environment, and that the trusted execution environment is trustworthy (i.e., is not compromised through lack of firmware updates or security holes). In many cases, the attestation process involves multiple computer systems—the user application requesting the so-called “Quote” (a data structure that is used to provide evidence to an off-platform entity that an application enclave runs with TEE protections in a TEE-enabled platform, e.g., with Intel® SGX protections on a trusted Intel® SGX enabled platform), an intermediary 10 (e.g., a driver or library) running on the computer system 100 (e.g., Intel® SGX DCAP (Data Center Attestation Primitives)), the remote attestation caching server 5 (e.g., Intel Provisioning certification caching service, PCCS), and the remote attestation server (not shown in FIG. 1a, e.g., Intel® Provisioning Certification Service, PCS).

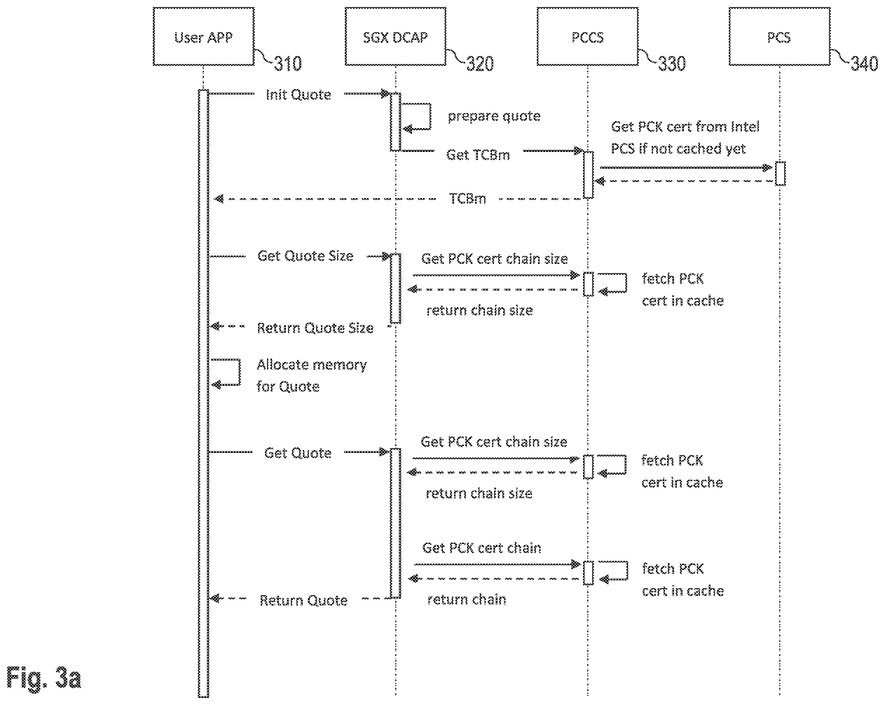

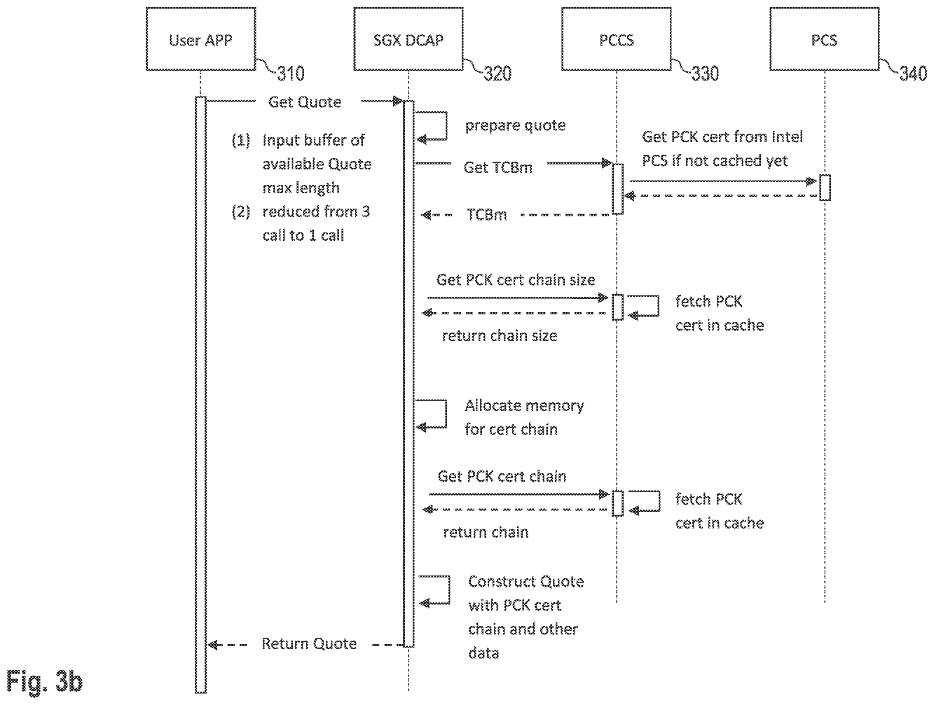

Various examples of the present disclosure are based on the finding, that the remote attestation of trustworthiness of a trusted execution environment via a caching server is often implemented as a multi-step process, with an application exchanging a number of messages with an intermediary (e.g., an API, or library), and with the intermediary again exchanging a number of messages with the remote attestation caching server. An example of such a message exchange is shown in FIG. 3a, for example. If the protocol, and corresponding message flow, is implemented as shown in FIG. 3a, the result is that only a single remote attestation caching server can be used for each sequence of requests, as subsequent requests may fail of the remote attestation caching server has not already cached the certificate chain (e.g., the Provisioning Certification Key, PCK, certificates).

In the proposed concept, this is avoided by simplifying the requests, with the intermediary, implemented by the apparatus 10, taking over coordination of the operations previously explicitly triggered by the user application. An example of this simplification is discussed in connection with FIG. 3b, for example, while the conventional flow is shown in FIG. 3a.

The process starts with obtaining the request to perform remote attestation for the trusted execution environment 14a from an application running (at least partially) in the trusted execution environment of the processor. For example, as shown in FIG. 3b, this request may correspond to a request to obtain a quote, i.e., a data structure that is used to provide evidence to an off-platform entity that an application enclave runs with TEE protections in a TEE-enabled platform. This request may comprise an identifier of the platform (e.g., the computer system). In other words, the request for remote attestation may comprise an identifier of a trusted computing platform of the computer system (with the trusted computing platform providing the trusted execution environment, e.g., an application enclave). This identifier may subsequently be included in requests for the remote attestation caching server, and thus used, by the PCCS, to download the certificate chain for the trusted computing platform even for subsequent requests following an initial request provided to the remote attestation platform.

The processor is to communicate with the at least one remote attestation caching server 5 based on the request to perform remote attestation, with the communication with the remote attestation caching server comprising providing a plurality of requests to the remote attestation server and obtaining a plurality of responses from the remote attestation caching server. In FIG. 3b, three requests (Get TCBm (Trusted Computing Base mappings), Get PCK (Provisioning Certification Key) certificate chain size, and Get PCK cert chain) and three responses (TCBm, chain size and chain) are shown. As outlined above, the processor may include the identifier of the trusted computing platform in each of the plurality of requests.

Accordingly, as further shown in FIG. 1b, the method may comprise including 122 the identifier of the trusted computing platform in each of the plurality of requests.

By including the identifier in (each of) the requests, the requests may even be provided to different remote attestation caching servers. For example, the processor may communicate with one of a plurality of remote attestation caching servers (at a time). Over time, one or more requests may be provided to a first remote attestation caching server, while one or more further requests may be provided to a second (or third) remote attestation caching server. For example, the processor may use an arbitrary number of remote attestation caching servers during the communication (e.g., 1 server up to the number of requests servers). In effect, the processor may communicate with at least one remote attestation caching server without a strong binding between the communication performed on behalf of the application and a remote attestation caching server. For example, the requests may be provided via a load-balancing mechanism or load-balancer and be provided to an arbitrary one of the plurality of remote attestation caching servers.

To simplify obtaining the result of the remote attestation request (i.e., the quote) for the application, the apparatus 10 may take over various tasks for the application. For example, as shown in FIG. 3b, the apparatus 10 may take over allocating memory for the certificate chain and preparing the quote, in memory of the apparatus 10, based on the certificate chain. For example, the processor may download the certificate chain from the remote attestation caching server as part of the communication, and prepare the result (i.e., the Quote) based on the certificate chain. Accordingly, as further shown in FIG. 1b, the method may comprise downloading 124 the certificate chain from the remote attestation caching server as part of the communication and preparing 126 the result based on the certificate chain. For example, the certificate chain, and thus also the result/Quote that is based on the certificate chain, attests that the trusted execution environment of the processor is capable of performing confidential computations. The processor 14 then provides the result of the remote attestation request, i.e., the quote, and optional further data, to the application running in the trusted execution environment after having completed the communication with the remote attestation server.

As is evident from FIG. 1b, the apparatus 10 (implemented by SGX DCAP 320 in FIG. 3b) takes over various tasks from the user application, without requiring further interaction with the user application, in contrast to the conventional scheme shown in FIG. 3a. Accordingly, as shown in FIG. 3b, the processor may perform the acts of obtaining the request, communicating with the at least one remote attestation caching server and providing the result of the remote attestation within a single session or a single contiguous function (indicated by the continuous bar shown at SGX DCAP 320 in FIG. 3b).

The functionality may be provided at different levels. As many applications need this functionality to attest to other entities that they run in a trustworthy manner, this functionality may be made available generally to different apps, to avoid apps having to re-implement this functionality themselves. For example, the processor may perform the acts of obtaining the request, communicating with the at least one remote attestation caching server and providing the result of the remote attestation as part of a driver (being accessible to the application), or as part of a software library (being accessible to the application).

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor 14 or means for processing 14 may be implemented using one or more processing units, one or more processing devices, any means for processing, such as a processor, a computer or a programmable hardware component being operable with accordingly adapted software. In other words, the described function of the processor 14 or means for processing may as well be implemented in software, which is then executed on one or more programmable hardware components. Such hardware components may comprise a general-purpose processor, a Digital Signal Processor (DSP), a micro-controller, etc. The processor 14 or means for processing 14 comprises a trusted execution environment, such as Intel® SGX.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be one of a workstation computer system, a server computer system, a personal computer system, a portable computer system, a mobile device, a smartphone, a tablet computer, or a laptop computer.

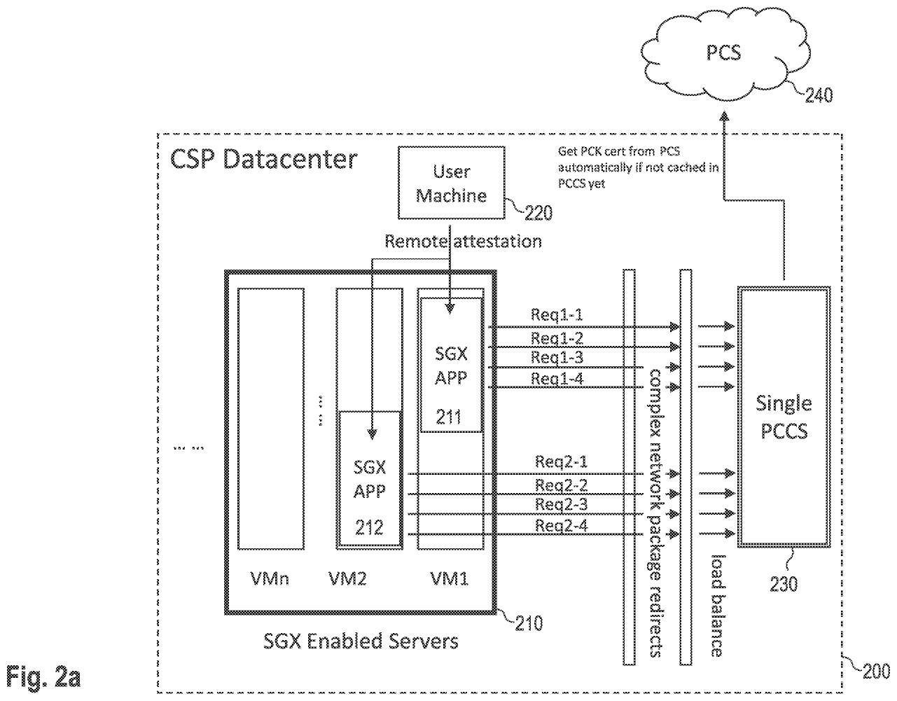

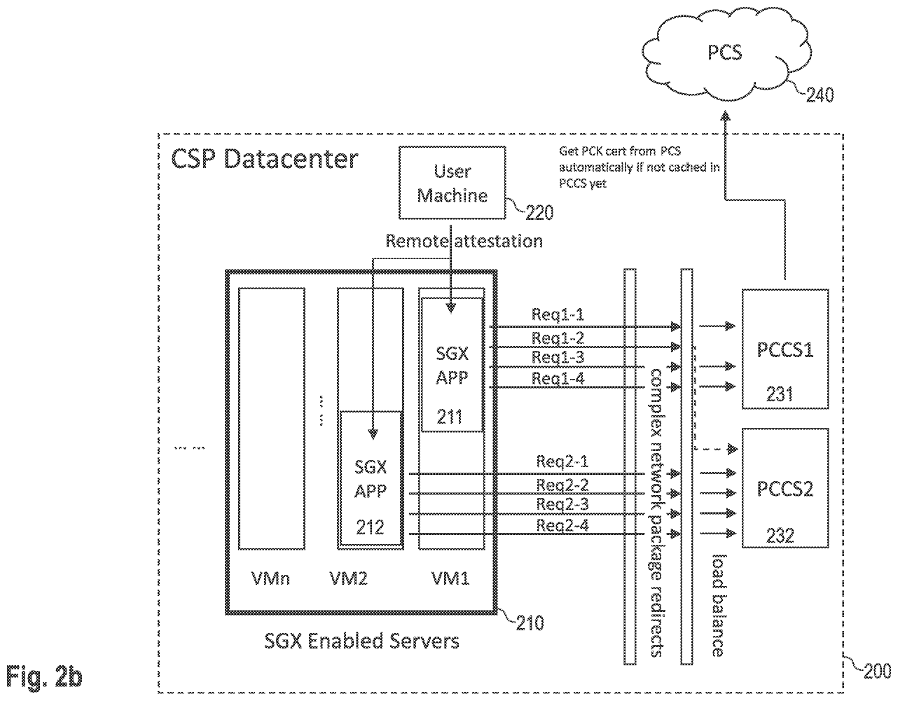

More details and aspects of the apparatus 10, device 10, method, a corresponding computer program and computer system 100 are mentioned in connection with the proposed concept or one or more examples described above or below (e.g., FIG. 2a to 7). The apparatus 10, device 10, method, the corresponding computer program and computer system 100 may comprise one or more additional optional features corresponding to one or more aspects of the proposed concept, or one or more examples described above or below.

Various examples relate to a concept for improving or optimizing a provisioning certification caching service protocol for performance improvement and scalability.

The Intel® PCCS (Provisioning certification caching service) is an important caching service, which is one of the components when deploying a zero-trust service. Operators, such as Cloud Service Providers (CSPs) leverage PCCS when using Intel® SGX (Software Guard Extensions) or TDX (Trust Domain Extensions) Intel® SGX is a confidential computation technology that can ensure code and data security at runtime. Various Intel processors are equipped with this technology. Intel® SGX remote attestation is a mechanism used to attest the integrity of the code and the SGX capability of the platform. After successful attestation, the SGX user then trusts the remote SGX server and subsequently transfers sensitive data to the SGX server. Intel® PCS (Provisioning Certification Service) is a service hosted by Intel on the Internet that offers APIs (Application Programming Interfaces) for retrieving Provisioning Certification Key (PCK) certificates and other endorsements for generating and verifying SGX Quotes. A PCK certificate is a Provisioning Certification Key certificate, the x.509 Certificate chain that is signed and distributed by the Registration Service for every SGX enabled multi-package platform. PCCS is the Provisioning Certification Caching Service, a remote attestation caching server, which allows a CSP (Cloud Service Provider) or a datacenter to cache PCK Certificates and other endorsements from the Intel® PCS in their local network. A Quote is a data structure that is used to provide evidence to an off-platform entity that an application enclave runs with Intel® SGX protections on a trusted Intel® SGX enabled platform.

While the following description oftentimes relates to Intel® PCS and PCCS, the proposed concept is applicable to various implementations of remote attestation caching servers and attestation services.

In the CSP environment, multiple remote attestation caching servers (e.g., PCCSs) are desired as each remote attestation caching server has a limited capacity, but many remote attestation caching servers, such as PCCSs, cannot support multiple deployments because the requests to the remote attestation caching server are stateful, which means that a request handled by a remote attestation caching server cannot be transferred to another remote attestation caching server to handle, and this limits the scaling deployment of remote attestation caching servers. In the following, a typical deployment example is shown with respect to Intel® PCCS and PCS.

FIG. 2a shows a schematic diagram of caching of provisioning certifications with a single caching server. FIG. 2a highlights a performance challenge in a single PCCS environment with many requests at the same time. FIG. 2a shows a CSP datacenter 200 with one or more SGX-enabled servers 210, which run virtual machines (VMs) 1-N, with some of the VMs hosting SGX applications 211; 212. A user machine 220 triggers remote attestation at the SGX apps 211; 212, which provide requests Req1-1-Req1-4, Req2-1-Req2-4 to a single PCCS 230 (via complex package redirects). The single PCCS can only serve ˜100 requests per second, which cannot satisfy big CSP's needs. The PCCS 230 obtains PCK certificates from the PCS 240 automatically if the respective certificates are not cached in PCCS yet. From FIG. 2a, it is evident that the single PCCS is the bottleneck. Although the PCCS can provide the service in time, the scalability may be considered suboptimal. When there are multiple requests from different SGX-enabled servers, the performance may be bad due to the capability of single PCCS.

FIG. 2b shows a schematic diagram of caching of provisioning certifications with multiple caching servers. In FIG. 2b, multiple PCCSs 231; 232 are used. If one of the requests (Req1-2) of one of the SGX apps (SGX app 211 in this case) reaches a different PCCS server than the other requests (Req1-1, Req1-3, Req1-4), the operation fails if the PCK certificate is not cached. Req1-2 will fail if sent to PCCS2 312, which has not cached the related PCK cert yet.

However, multiple PCCS may be desired in big CSP environments for performance reasons. A single PCCS works well for small-scale use, but one PCCS can only serve about 100 requests per second, so single PCCSs might fit the use scenario of big CSP, where dozens or even hundreds of PCCS are needed. However, multiple PCCS may not be workable in the design of the PCCS. In the remote attestation process, in some implementations, as shown in FIG. 3a, a total of 4 requests will be sent to PCCS. In multiple PCCS environments, if any of the second/third/fourth requests are sent to a PCCS which has not cached the related PCK certificate, then the request may fail. Moreover, there may be newly added requests, which will continue influencing the scaling deployment of PCCS.

The proposed concept addresses the PCCS, or more general the remote attestation caching server, scaling issue. In the proposed concept, the sub-requests are merged into a few requests, so that the resulting request to PCCS becomes stateless and can be sent to any PCCS regardless of the related PCK cert being cached or not.

Some operators avoid this failure by manually pre-caching the PCK cert in all the PCCS. However, when deploying a new PCCS, the CSP needs to pre-cache the PCCS manually. When a new machine (on which the SGX VM (Virtual Machines)) is added, the CSP needs to pre-cache all the PCCS for this newly added machine. Pre-caching may introduce increased complexity for SGX deployment.

In the proposed concept, the sub-requests are merged into a single request, so that the request to PCCS becomes stateless and can be sent to any PCCS regardless of whether the PCK certificate is cached or not. Thus, the protocol for communicating with the remote attestation caching server is redesigned, while retaining the same functionalities and maintaining compatibility with the existing protocols.

Multiple PCCS can work in a stateless manner so that CSPs can scale out or shrink PCCS dynamically based on their business needs using tools like an orchestration service (e.g., kubernetes).

The proposed concept is based on making the request to the emote attestation caching server (e.g., the PCCS) stateless, which enables scaling the number of emote attestation caching servers up and down in a convenient manner.

FIG. 3a shows a flow diagram of an example of a caching flow for obtaining a quote in remote attestation (with stateful requests). FIGS. 3a and 3b show four entities—the user application 310, the SGX DCAP (Data Center Attestation Primitives) 320, the PCCS 330 and the PCS 340. In the example of FIG. 3b, the user application may correspond to the application discussed in connection with FIGS. 1a and/or 1b, the SGX DCAP 320 may be implemented by the apparatus 10 or device 10 of FIG. 1a, and the PCCS 330 may correspond to the remote attestation caching server 5 of FIG. 1a.

In FIG. 3a, the User App 310 negotiates with SGX DCAP 320 (Data Center Attestation Primitives) module 3 times—(1) Init Quote, (2) Get Quote Size and (3) Get Quote. The SGX DCAP (Data Center Attestation Primitives) 320 then calls the PCCS 330 four times: (1) Get TCBm, (2) Get PCK cert chain size when user app requires Quote size, (3) Get PCK cert chain size again before getting PCK cert chain from PCCS, and (4) Get PCK cert chain. Calls (2)-(4) cannot be sent to a PCCS without the related cache, otherwise the request will fail.

FIG. 3b shows a flow diagram of an example of an improved caching flow for obtaining a quote in remote attestation. In FIG. 3b, the three SGX DCAP calls (from the User App 310 to the SGX DCAP 320) are merged to a single call (Get Quote). In addition, four PCCS calls (from SGX DCAP 320 to PCCS 330) are reduced to 3. In the first call (Get TCBm, which is based on the prepare quote call), it includes the key information—encrypted_ppid (the identifier mentioned in connection with FIGS. 1a to 1b) which can be used (i.e., included) in the second and third calls. So, any PCCS can handle such a request well. In this way, PCCS accessing becomes stateless.

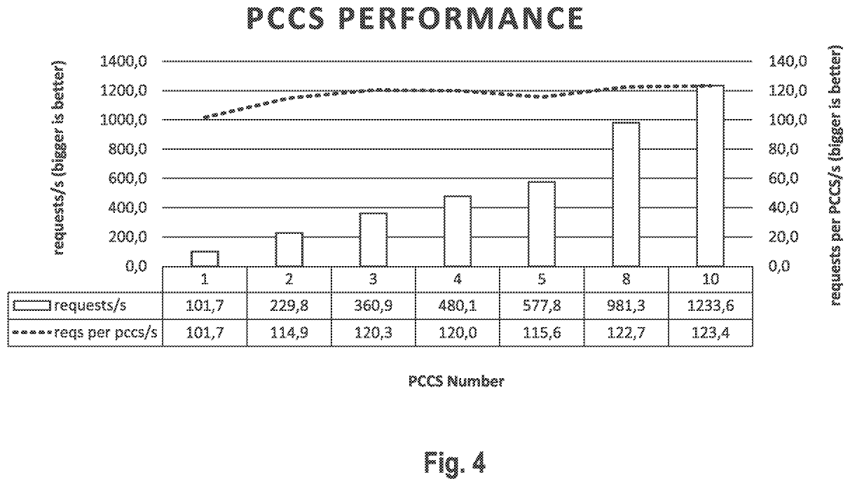

FIG. 4 shows a diagram highlighting performance improvements obtained by scaling a number of caching servers. With the improvements shown in FIG. 3b, a benchmark was established to demonstrate the scalability of the proposed concept. In the benchmark, Kubernetes was used to scale out PCCS. The result shows that one PCCS can handle 101.7 requests per second. While increasing the PCCS number to 2, 3, to 10, the PCCS cluster can linearly handle more requests. Meanwhile, the capability of each PCCS stays in the range of 100-125 requests/s. This demonstrates that the proposed methodology is suitable for the task at hand.

In summary, single remote attestation caching server deployment is the bottleneck when there are multiple concurrent requests at the same time. For example, if there is a large number of services deployed on the different servers to boot up at the same time, one remote attestation caching server becomes a bottleneck. To overcome the bottleneck, multiple remote attestation caching server are deployed, using the proposed concept to avoid failure due to stateful attestation requests. In the proposed concept, the requests are consolidated, resulting in a lower number of requests as well, which may further increase the efficiency. This improves the scalability of trusted execution environments in zero-trust settings, e.g., using SGX and TDX.

More details and aspects of the concept for improving or optimizing a provisioning certification caching service protocol are mentioned in connection with the proposed concept or one or more examples described above or below (e.g., FIG. 1a to 1b, 5 to 7). The concept for improving or optimizing a provisioning certification caching service protocol may comprise one or more additional optional features corresponding to one or more aspects of the proposed concept, or one or more examples described above or below.

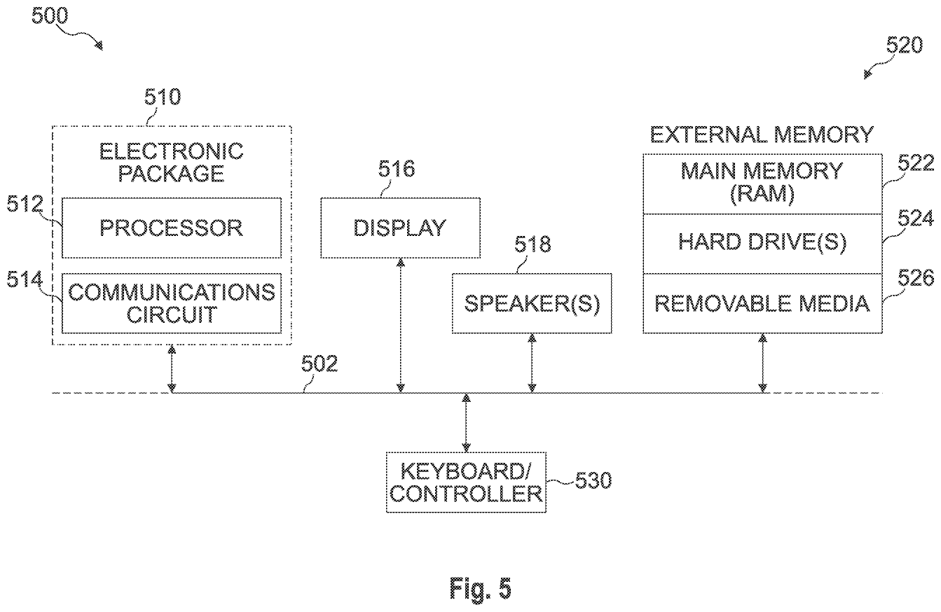

FIG. 5 is a block diagram of an electronic apparatus 500 incorporating at least one electronic assembly and/or method described herein. Electronic apparatus 500 is-merely one example of an electronic apparatus in which forms of the electronic assemblies and/or methods described herein may be used. Examples of an electronic apparatus 500 include, but are not limited to, personal computers, tablet computers, mobile telephones, game devices, MP3 or other digital music players, etc. In this example, electronic apparatus 500 comprises a data processing system that includes a system bus 502 to couple the various components of the electronic apparatus 500. System bus 502 provides communications links among the various components of the electronic apparatus 500 and may be implemented as a single bus, as a combination of busses, or in any other suitable manner.

An electronic assembly 510 as describe herein may be coupled to system bus 502. The electronic assembly 510 may include any circuit or combination of circuits. In one embodiment, the electronic assembly 510 includes a processor 512 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 510 are a custom circuit, an application-specific integrated circuit (ASlC), or the like, such as, for example, one or more circuits (such as a communications circuit 514) for use in wireless devices like mobile telephones, tablet computers, laptop computers, two-way radios, and similar electronic systems. The IC can perform any other type of function.

The electronic apparatus 500 may also include an external memory 520, which in turn may include one or more memory elements suitable to the particular application, such as a main memory 522 in the form of random-access memory (RAM), one or more hard drives 524, and/or one or more drives that handle removable media 526 such as compact disks (CD), flash memory cards, digital video disk (DVD), and the like.

The electronic apparatus 500 may also include a display device 516, one or more speakers 518, and a keyboard and/or controller 530, which can include a mouse, trackball, touch screen, voice-recognition device, or any other device that permits a system user to input information into and receive information from the electronic apparatus 500.

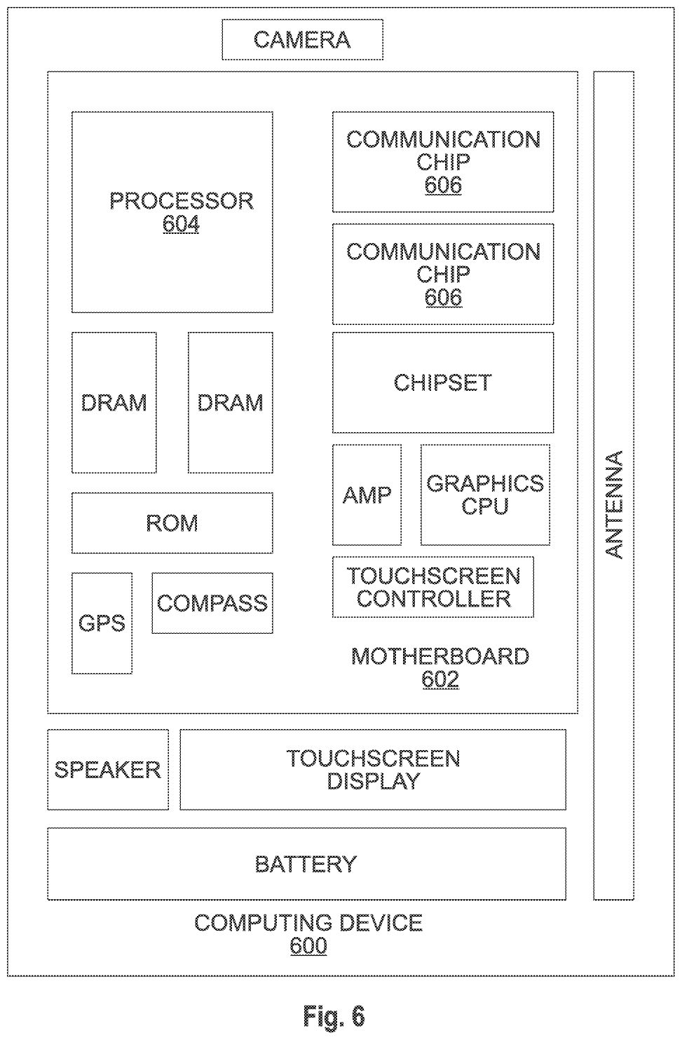

FIG. 6 illustrates a computing device 600 in accordance with one implementation of the invention. The computing device 600 houses a board 602. The board 602 may include a number of components, including but not limited to a processor 604 and at least one communication chip 606. The processor 604 is physically and electrically coupled to the board 602. In some implementations the at least one communication chip 606 is also physically and electrically coupled to the board 602. In further implementations, the communication chip 606 is part of the processor 604. Depending on its applications, computing device 600 may include other components that may or may not be physically and electrically coupled to the board 602. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others. The processor 604 of the computing device 600 includes an integrated circuit die packaged within the processor 604. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 606 also includes an integrated circuit die packaged within the communication chip 606. In accordance with another implementation of the invention, the integrated circuit die of the communication chip includes one or more devices that are assembled in an ePLB or eWLB based POP package that that includes a mold layer directly contacting a substrate, in accordance with implementations of the invention.

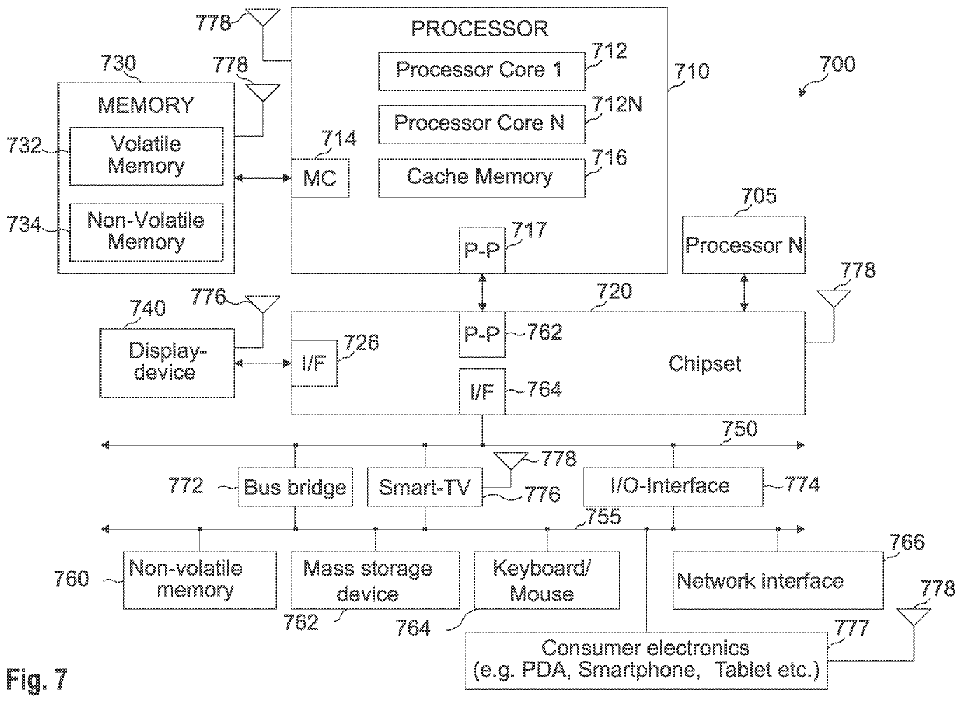

FIG. 7 is included to show an example of a higher-level device application for the disclosed embodiments. In an embodiment, a computing system 700 includes, but is not limited to, a desktop computer. In an embodiment, a system 700 includes, but is not limited to a laptop computer. In an embodiment, a system 700 includes, but is not limited to a netbook. In an embodiment, a system 700 includes, but is not limited to a tablet. In an embodiment, a system 700 includes, but is not limited to a notebook computer. In an embodiment, a system 700 includes, but is not limited to a personal digital assistant (PDA). In an embodiment, a system 700 includes, but is not limited to a server. In an embodiment, a system 700 includes, but is not limited to a workstation. In an embodiment, a system 700 includes, but is not limited to a cellular telephone. In an embodiment, a system 700 includes, but is not limited to a mobile computing device. In an embodiment, a system 700 includes, but is not limited to a smart phone. In an embodiment, a system 700 includes, but is not limited to an internet appliance.

In an embodiment, the processor 710 has one or more processing cores 712 and 712N, where 712N represents the Nth processor core inside processor 710 where N is a positive integer. In an embodiment, the electronic device system 700 using a MAA apparatus embodiment that includes multiple processors including 710 and 705, where the processor 705 has logic similar or identical to the logic of the processor 710. In an embodiment, the processing core 712 includes, but is not limited to, pre-fetch logic to fetch instructions, decode logic to decode the instructions, execution logic to execute instructions and the like. In an embodiment, the processor 710 has a cache memory 716 to cache at least one of instructions and data for the apparatus in the system 700. The cache memory 716 may be organized into a hierarchal structure including one or more levels of cache memory.

In an embodiment, the processor 710 includes a memory controller 714, which is operable to perform functions that enable the processor 710 to access and communicate with memory 730 that includes at least one of a volatile memory 732 and a non-volatile memory 734. In an embodiment, the processor 710 is coupled with memory 730 and chipset 720. The processor 710 may also be coupled to a wireless antenna 778 to communicate with any device configured to at least one of transmit and receive wireless signals. In an embodiment, the wireless antenna interface 778 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 732 includes, but is not limited to, Synchronous Dynamic Random Access Memory (SDRAM), Dynamic Random Access Memory (DRAM), RAMBUS Dynamic Random Access Memory (RDRAM), and/or any other type of random-access memory device. The non-volatile memory 734 includes, but is not limited to, flash memory, phase change memory (PCM), read-only memory (ROM), electrically erasable programmable read-only memory (EEPROM), or any other type of non-volatile memory device.

The memory 730 stores information and instructions to be executed by the processor 710. In an embodiment, the memory 730 may also store temporary variables or other intermediate information while the processor 710 is executing instructions. In the illustrated embodiment, the chipset 720 connects with processor 710 via Point-to-Point (PtP or P-P) interfaces 717 and 722. Either of these PtP embodiments may be achieved using a MAA apparatus embodiment as set forth in this disclosure. The chipset 720 enables the processor 710 to connect to other elements in the MAA apparatus embodiments in a system 700. In an embodiment, interfaces 717 and 722 operate in accordance with a PtP communication protocol such as the Intel® QuickPath Interconnect (QPI) or the like. In other embodiments, a different interconnect may be used.

In an embodiment, the chipset 720 is operable to communicate with the processor 710, 705N, the display device 740, and other devices 772, 776, 774, 760, 762, 764, 766, 777, etc. The chipset 720 may also be coupled to a wireless antenna 778 to communicate with any device configured to at least do one of transmit and receive wireless signals.

The chipset 720 connects to the display device 740 via the interface 726. The display 740 may be, for example, a liquid crystal display (LCD), a plasma display, cathode ray tube (CRT) display, or any other form of visual display device. In and embodiment, the processor 710 and the chipset 720 are merged into a MAA apparatus in a system. Additionally, the chipset 720 connects to one or more buses 750 and 755 that interconnect various elements 774, 760, 762, 764, and 766. Buses 750 and 755 may be interconnected together via a bus bridge 772 such as at least one MAA apparatus embodiment. In an embodiment, the chipset 720 couples with a non-volatile memory 760, a mass storage device(s) 762, a keyboard/mouse 764, and a network interface 766 by way of at least one of the interface 724 and 774, the smart TV 776, and the consumer electronics 777, etc.

In an embodiment, the mass storage device 762 includes, but is not limited to, a solid-state drive, a hard disk drive, a universal serial bus flash memory drive, or any other form of computer data storage medium. In one embodiment, the network interface 766 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 7 are depicted as separate blocks within the MAA apparatus embodiment in a computing system 700, the functions performed by some of these blocks may be integrated within a single semiconductor circuit or may be implemented using two or more separate integrated circuits. For example, although cache memory 716 is depicted as a separate block within processor 710, cache memory 716 (or selected aspects of 716) can be incorporated into the processor core 712.

In the following, some examples of the proposed concept are presented:

An example (e.g., example 1) relates to an apparatus (10) for a computer system (100), the apparatus comprising interface circuitry (12), machine-readable instructions, and a processor (14) to execute the machine-readable instructions to obtain a request to perform remote attestation for a trusted execution environment (14a) from an application running in the trusted execution environment of the processor. The processor is to execute the machine-readable instructions to communicate with at least one remote attestation caching server (5) based on the request to perform remote attestation, wherein the communication with the remote attestation caching server comprises providing a plurality of requests to the remote attestation server and obtaining a plurality of responses from the remote attestation caching server. The processor is to execute the machine-readable instructions to provide a result of the remote attestation request to the application running in the trusted execution environment after having completed the communication with the remote attestation server.

Another example (e.g., example 2) relates to a previously described example (e.g., example 1) or to any of the examples described herein, further comprising that the processor is to execute the machine-readable instructions to communicate with one of a plurality of remote attestation caching servers.

Another example (e.g., example 3) relates to a previously described example (e.g., example 2) or to any of the examples described herein, further comprising that the processor is to execute the machine-readable instructions to use an arbitrary number of remote attestation caching servers during the communication.

Another example (e.g., example 4) relates to a previously described example (e.g., one of the examples 2 to 3) or to any of the examples described herein, further comprising that the processor is to execute the machine-readable instructions to communicate with the at least one remote attestation caching server without a binding between the communication performed on behalf of the application and a remote attestation caching server.

Another example (e.g., example 5) relates to a previously described example (e.g., one of the examples 2 to 4) or to any of the examples described herein, further comprising that the request for remote attestation comprises an identifier of a trusted computing platform of the computer system, wherein the processor is to include the identifier of the trusted computing platform in each of the plurality of requests.

Another example (e.g., example 6) relates to a previously described example (e.g., one of the examples 1 to 5) or to any of the examples described herein, further comprising that the processor is to execute the machine-readable instructions to perform the acts of obtaining the request, communicating with the at least one remote attestation caching server and providing the result of the remote attestation within a single session or a single contiguous function.

Another example (e.g., example 7) relates to a previously described example (e.g., one of the examples 1 to 6) or to any of the examples described herein, further comprising that the processor is to execute the machine-readable instructions to perform the acts of obtaining the request, communicating with the at least one remote attestation caching server and providing the result of the remote attestation as part of a driver.

Another example (e.g., example 8) relates to a previously described example (e.g., one of the examples 1 to 6) or to any of the examples described herein, further comprising that the processor is to execute the machine-readable instructions to perform the acts of obtaining the request, communicating with the at least one remote attestation caching server and providing the result of the remote attestation as part of a software library.

Another example (e.g., example 9) relates to a previously described example (e.g., one of the examples 1 to 8) or to any of the examples described herein, further comprising that the processor is to execute the machine-readable instructions to download a certificate chain from the remote attestation caching server as part of the communication, and to prepare the result based on the certificate chain.

Another example (e.g., example 10) relates to a previously described example (e.g., example 9) or to any of the examples described herein, further comprising that the certificate chain attests that the trusted execution environment of the processor is capable of performing confidential computations.

An example (e.g., example 11) relates to an apparatus (10) for a computer system (100), the apparatus comprising a processor (14) configured to obtain a request to perform remote attestation for a trusted execution environment (14a) from an application running in the trusted execution environment of the processor. The processor is configured to communicate with at least one remote attestation caching server (5) based on the request to perform remote attestation, wherein the communication with the remote attestation caching server comprises providing a plurality of requests to the remote attestation server and obtaining a plurality of responses from the remote attestation caching server. The processor is configured to provide a result of the remote attestation request to the application running in the trusted execution environment after having completed the communication with the remote attestation server.

An example (e.g., example 12) relates to a device (10) for a computer system (100), the device comprising means for processing (14) for obtaining a request to perform remote attestation for a trusted execution environment (14a) from an application running in the trusted execution environment of the means for processing. The means for processing is for communicating with at least one remote attestation caching server (5) based on the request to perform remote attestation, wherein the communication with the remote attestation caching server comprises providing a plurality of requests to the remote attestation server and obtaining a plurality of responses from the remote attestation caching server. The means for processing is for providing a result of the remote attestation request to the application running in the trusted execution environment after having completed the communication with the remote attestation server.

An example (e.g., example 13) relates to a computer system (100) comprising the apparatus (10) or device (10) according to one of the examples 1 to 12 (or according to any other example).

An example (e.g., example 14) relates to a method for a computer system (100), the method comprising obtaining (110) a request to perform remote attestation for a trusted execution environment from an application running in the trusted execution environment of a processor of the computer system. The method comprises communicating (120) with at least one remote attestation caching server (5) based on the request to perform remote attestation, wherein the communication with the remote attestation caching server comprises providing a plurality of requests to the remote attestation server and obtaining a plurality of responses from the remote attestation caching server. The method comprises providing (130) a result of the remote attestation request to the application running in the trusted execution environment after having completed the communication with the remote attestation server.

Another example (e.g., example 15) relates to a previously described example (e.g., example 14) or to any of the examples described herein, further comprising that the method comprises communicating (120) with one of a plurality of remote attestation caching servers.

Another example (e.g., example 16) relates to a previously described example (e.g., example 15) or to any of the examples described herein, further comprising that the method comprises using an arbitrary number of remote attestation caching servers during the communication (120).

Another example (e.g., example 17) relates to a previously described example (e.g., one of the examples 15 to 16) or to any of the examples described herein, further comprising that the method comprises communicating (120) with at least one remote attestation caching server without a binding between the communication performed on behalf of the application and a remote attestation caching server.

Another example (e.g., example 18) relates to a previously described example (e.g., one of the examples 15 to 17) or to any of the examples described herein, further comprising that the request for remote attestation comprises an identifier of a trusted computing platform of the computer system, wherein the method comprises including (122) the identifier of the trusted computing platform in each of the plurality of requests.

Another example (e.g., example 19) relates to a previously described example (e.g., one of the examples 14 to 18) or to any of the examples described herein, further comprising that the acts of obtaining the request, communicating with the at least one remote attestation caching server and providing the result of the remote attestation are performed within a single session or a single contiguous function.

Another example (e.g., example 20) relates to a previously described example (e.g., one of the examples 14 to 18) or to any of the examples described herein, further comprising that the acts of obtaining the request, communicating with the at least one remote attestation caching server and providing the result of the remote attestation are performed by a driver.

Another example (e.g., example 21) relates to a previously described example (e.g., one of the examples 14 to 20) or to any of the examples described herein, further comprising that the acts of obtaining the request, communicating with the at least one remote attestation caching server and providing the result of the remote attestation are performed by a software library.

Another example (e.g., example 22) relates to a previously described example (e.g., one of the examples 14 to 21) or to any of the examples described herein, further comprising that the method comprises downloading (124) a certificate chain from the remote attestation caching server as part of the communication and preparing (126) the result based on the certificate chain.

Another example (e.g., example 23) relates to a previously described example (e.g., example 22) or to any of the examples described herein, further comprising that the certificate chain attests that the trusted execution environment of the processor is capable of performing confidential computations.

An example (e.g., example 24) relates to a non-transitory, computer-readable medium comprising a program code that, when the program code is executed on a processor, a computer, or a programmable hardware component, causes the processor, computer, or programmable hardware component to perform the method according to one of the examples 14 to 23 (or according to any other example).

An example (e.g., example 25) relates to a computer system (100) being configured to perform the method according to one of the examples 14 to 23 (or according to any other example).

An example (e.g., example 26) relates to a non-transitory machine-readable storage medium including program code, when executed, to cause a machine to perform the method of one of the examples 14 to 23 (or according to any other example).

An example (e.g., example 27) relates to a computer program having a program code for performing the method of one of the examples 14 to 23 (or according to any other example) when the computer program is executed on a computer, a processor, or a programmable hardware component.

An example (e.g., example 28) relates to a machine-readable storage including machine readable instructions, when executed, to implement a method or realize an apparatus as claimed in any pending claim or shown in any example.

Example A1 relates to an apparatus for optimizing Provisioning Certification Caching Service protocol according to one of examples of the specification.

Example A2 relates to a method for optimizing Provisioning Certification Caching Service protocol according to one of examples of the specification.

Example A3 relates to a computer program for optimizing Provisioning Certification Caching Service protocol according to one of examples of the specification.

Example A4 relates to a machine-readable medium including code, when executed, to cause a machine to perform any of the methods for optimizing Provisioning Certification Caching Service protocol according to one of examples of the specification.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable, or computer-executable programs and instructions. Program storage devices may include or be digital storage devices, magnetic storage media such as magnetic disks and magnetic tapes, hard disk drives, or optically readable digital data storage media, for example.

Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising interface circuitry, machine-readable instructions, and a processor to execute the machine-readable instructions to:
obtain a request to perform remote attestation for a trusted execution environment from an application running in the trusted execution environment of the processor;
communicate with at least one remote attestation caching server based on the request to perform remote attestation, wherein the communication with the remote attestation caching server comprises providing a plurality of requests to the remote attestation server and obtaining a plurality of responses from the remote attestation caching server; and
provide a result of the remote attestation request to the application running in the trusted execution environment after having completed the communication with the remote attestation server.

2. The apparatus according to claim 1, wherein the processor is to execute the machine-readable instructions to communicate with one of a plurality of remote attestation caching servers.

3. The apparatus according to claim 2, wherein the processor is to execute the machine-readable instructions to use an arbitrary number of remote attestation caching servers during the communication.

4. The apparatus according to claim 2, wherein the processor is to execute the machine-readable instructions to communicate with the at least one remote attestation caching server without a binding between the communication performed on behalf of the application and a remote attestation caching server.

5. The apparatus according to claim 2, wherein the request for remote attestation comprises an identifier of a trusted computing platform of the computer system, wherein the processor is to include the identifier of the trusted computing platform in each of the plurality of requests.

6. The apparatus according to claim 1, wherein the processor is to execute the machine-readable instructions to perform the acts of obtaining the request, communicating with the at least one remote attestation caching server and providing the result of the remote attestation within a single session or a single contiguous function.

7. The apparatus according to claim 1, wherein the processor is to execute the machine-readable instructions to perform the acts of obtaining the request, communicating with the at least one remote attestation caching server and providing the result of the remote attestation as part of a driver.

8. The apparatus according to claim 1, wherein the processor is to execute the machine-readable instructions to perform the acts of obtaining the request, communicating with the at least one remote attestation caching server and providing the result of the remote attestation as part of a software library.

9. The apparatus according to claim 1, wherein the processor is to execute the machine-readable instructions to download a certificate chain from the remote attestation caching server as part of the communication, and to prepare the result based on the certificate chain.

10. The apparatus according to claim 9, wherein the certificate chain attests that the trusted execution environment of the processor is capable of performing confidential computations.

11. A method for a computer system, the method comprising:
obtaining a request to perform remote attestation for a trusted execution environment from an application running in the trusted execution environment of a processor of the computer system;
communicating with at least one remote attestation caching server (5) based on the request to perform remote attestation, wherein the communication with the remote attestation caching server comprises providing a plurality of requests to the remote attestation server and obtaining a plurality of responses from the remote attestation caching server; and
providing a result of the remote attestation request to the application running in the trusted execution environment after having completed the communication with the remote attestation server.

12. The method according to claim 11, wherein the method comprises communicating with one of a plurality of remote attestation caching servers.

13. The method according to claim 12, wherein the method comprises using an arbitrary number of remote attestation caching servers during the communication.

14. The method according to claim 12, wherein the method comprises communicating with at least one remote attestation caching server without a binding between the communication performed on behalf of the application and a remote attestation caching server.

15. The method according to claim 12, wherein the request for remote attestation comprises an identifier of a trusted computing platform of the computer system, wherein the method comprises including the identifier of the trusted computing platform in each of the plurality of requests.

16. The method according to claim 11, wherein the acts of obtaining the request, communicating with the at least one remote attestation caching server and providing the result of the remote attestation are performed within a single session or a single contiguous function.

17. The method according to claim 11, wherein the acts of obtaining the request, communicating with the at least one remote attestation caching server and providing the result of the remote attestation are performed by a driver.

18. The method according to claim 11, wherein the acts of obtaining the request, communicating with the at least one remote attestation caching server and providing the result of the remote attestation are performed by a software library.

19. The method according to claim 11, wherein the method comprises downloading a certificate chain from the remote attestation caching server as part of the communication and preparing the result based on the certificate chain.

20. A non-transitory, computer-readable medium comprising a program code that, when the program code is executed on a processor, a computer, or a programmable hardware component, causes the processor, computer, or programmable hardware component to perform the method according to claim 11.
